(19) United States
(12) Patent Application Publication
(10) Pub. No.: US 2026/0261311 A1
(43) Pub. Date: Sep. 3, 2026

(54) DEVICES, METHODS, APPARATUSES, AND COMPUTER READABLE MEDIA FOR TERAHERTZ CHANNEL COMMUNICATION

(71) Applicant: Nokia Solutions and Networks Oy, Espoo (FI)

(72) Inventors: Wenjian Wang, Shanghai (CN); Jianguo Liu, Shanghai (CN); Yanni Zhou, Shanghai (CN)

(21) Appl. No.: 19/164,383

(22) PCT Filed: Mar. 13, 2023
(86) PCT No.: PCT/CN2023/080988

§ 371 Date: Sep. 11, 2025

(51) Int. Cl. H04B 7/06; H04L 1/00

(52) U.S. Cl. CPC H04B 7/0626; H04L 1/0003

(57) ABSTRACT

Disclosed are devices, methods, apparatuses, and computer readable media for terahertz channel communication. An example terminal device for communication may include at least one processor and at least one memory. The at least one memory may store instructions that, when executed by the at least one processor, may cause the terminal device at least to perform: receiving from a serving network device, distance aware information comprising a distance-bandwidth mapping table; deciding an available bandwidth based on the distance-bandwidth mapping table; determining terminal aware information of the terminal device; and transmitting to a serving network device, the terminal aware information, wherein the terminal aware information comprises positioning information and channel state information, and optionally information on the available bandwidth.

### TECHNICAL FIELD

Various example embodiments relate to devices, methods, apparatuses, and computer readable media for terahertz channel communication.

### BACKGROUND

Terahertz (THz) channel provides wireless communication devices with a band ranging from several tens of GHz up to a few THz. Some phenomenon may cause path loss of THz channel. For example, the absorption by water vapor molecules may affect the propagation of THz-band signals. The path loss may be different for different transmission distances. For communication distances below one meter, the THz band behaves as a single transmission window of several THz wide. As the transmission distance increases, the molecular absorption may cause multiple transmission sub-windows separated by absorption lines. Moreover, the absorption line peaks become both stronger and wider and the band of each individual transmission sub-window shrinks with the increasing of transmission distance.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device for communication. The terminal device may include at least one processor and at least one memory. The at least one memory may store instructions that, when executed by the at least one processor, may cause the terminal device at least to perform: receiving from a serving network device, distance aware information comprising a distance-bandwidth mapping table; deciding an available bandwidth based on the distance-bandwidth mapping table; determining terminal aware information of the terminal device; and transmitting to the serving network device, the terminal aware information, wherein the terminal aware information comprises positioning information and channel state information, and optionally information on the available bandwidth.

In a second aspect, disclosed is a network device for communication. The network device may include at least one processor and at least one memory. The at least one memory may store instructions that, when executed by the at least one processor, may cause the network device at least to perform: transmitting to a plurality of terminal devices, distance aware information comprising a distance-bandwidth mapping table; receiving from at least part of the plurality of terminal devices, respective terminal aware information comprising positioning information and channel state information, and optionally information on an available bandwidth; pairwise coupling the at least part of the plurality of terminal devices based on the respective terminal aware information to form one or more pairs of terminal devices, a pair of terminal devices comprising a closer terminal device and a farther terminal device; and performing a hybrid modulation mode for the one or more pairs of terminal devices, respectively, the hybrid modulation mode comprising a hierarchical type modulation and another type modulation.

In a third aspect, disclosed is a method for communication performed by a terminal device. The method may comprise: receiving from a serving network device, distance aware information comprising a distance-bandwidth mapping table; deciding an available bandwidth based on the distance-bandwidth mapping table; determining terminal aware information of the terminal device; and transmitting to the serving network device, the terminal aware information, wherein the terminal aware information comprises positioning information and channel state information, and optionally information on the available bandwidth.

In a fourth aspect, disclosed is a method for communication performed by a network device. The method may comprise: transmitting to a plurality of terminal devices, distance aware information comprising a distance-bandwidth mapping table; receiving from at least part of the plurality of terminal devices, respective terminal aware information comprising positioning information and channel state information, and optionally information on an available bandwidth; pairwise coupling the at least part of the plurality of terminal devices based on the respective terminal aware information to form one or more pairs of terminal devices, a pair of terminal devices comprising a closer terminal device and a farther terminal device; and performing a hybrid modulation mode for the one or more pairs of terminal devices, respectively, the hybrid modulation mode comprising a hierarchical type modulation and another type modulation.

In a fifth aspect, disclosed is an apparatus as a terminal device for communication. The apparatus may comprise: means for receiving from a serving network device, distance aware information comprising a distance-bandwidth mapping table; means for deciding an available bandwidth based on the distance-bandwidth mapping table; means for determining terminal aware information of the terminal device; and means for transmitting to the serving network device, the terminal aware information, wherein the terminal aware information comprises positioning information and channel state information, and optionally information on the available bandwidth.

In a sixth aspect, disclosed is an apparatus as a network device for communication. The apparatus may comprise: means for transmitting to a plurality of terminal devices, distance aware information comprising a distance-bandwidth mapping table; means for receiving from at least part of the plurality of terminal devices, respective terminal aware information comprising positioning information and channel state information, and optionally information on an available bandwidth; means for pairwise coupling the at least part of the plurality of terminal devices based on the respective terminal aware information to form one or more pairs of terminal devices, a pair of terminal devices comprising a closer terminal device and a farther terminal device; and means for performing a hybrid modulation mode for the one or more pairs of terminal devices, respectively, the hybrid modulation mode comprising a hierarchical type modulation and another type modulation.

In a seventh aspect, a computer readable medium is disclosed. The computer readable medium may comprise program instructions that, when executed by a terminal device for communication, may cause the terminal device at least to perform: receiving from a serving network device, distance aware information comprising a distance-bandwidth mapping table; deciding an available bandwidth based on the distance-bandwidth mapping table; determining terminal aware information of the terminal device; and transmitting to the serving network device, the terminal aware information, wherein the terminal aware information comprises positioning information and channel state information, and optionally information on the available bandwidth.

In an eighth aspect, a computer readable medium is disclosed. The computer readable medium may comprise program instructions that, when executed by a network device for communication, cause the network device at least to perform: transmitting to a plurality of terminal devices, distance aware information comprising a distance-bandwidth mapping table; receiving from at least part of the plurality of terminal devices, respective terminal aware information comprising positioning information and channel state information, and optionally information on an available bandwidth; pairwise coupling the at least part of the plurality of terminal devices based on the respective terminal aware information to form one or more pairs of terminal devices, a pair of terminal devices comprising a closer terminal device and a farther terminal device; and performing a hybrid modulation mode for the one or more pairs of terminal devices, respectively, the hybrid modulation mode comprising a hierarchical type modulation and another type modulation.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an example of a band of a transmission window in THz band to which the example embodiments of the present disclosure may be implemented.

FIG. 2 shows an exemplary sequence diagram for a mechanism of the hybrid adaptive modulation mode according to example embodiments of the present disclosure.

FIG. 3 shows an example scenario to which the example embodiments of the hybrid modulation mode according to the present disclosure may be implemented.

FIG. 4 shows an exemplary flow diagram for performing the hybrid modulation mode according to example embodiments of the present disclosure.

FIG. 5 shows an exemplary sequence diagram for triggering the modulation mode reconfiguration according to example embodiments of the present disclosure.

FIG. 6 shows simulation curves of the data rate according to different modulation modes.

FIG. 7 shows simulation curves of the modulation orders according to different modulation modes.

FIG. 8 shows simulation curves of the probabilities that the modulation mode is adjusted according to example embodiments of the present disclosure.

FIG. 9 shows a flow chart illustrating an example method 900 for terahertz channel communication according to the example embodiments of the present disclosure.

FIG. 10 shows a flow chart illustrating an example method 1000 for terahertz channel communication according to the example embodiments of the present disclosure.

FIG. 11 shows a block diagram illustrating an example device 1100 for terahertz channel communication according to the example embodiments of the present disclosure.

FIG. 12 shows a block diagram illustrating an example device 1200 for terahertz channel communication according to the example embodiments of the present disclosure.

FIG. 13 shows a block diagram illustrating an example apparatus 1300 for terahertz channel communication according to the example embodiments of the present disclosure.

FIG. 14 shows a block diagram illustrating an example apparatus 1400 for terahertz channel communication according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a hybrid adaptive modulation mode for THz channel communication as well as communication on a channel of frequency band higher than THz, collectively referred to as for THz channel communication in present disclosure. According to the embodiments of the present disclosure, a joint optimization mode in high-frequency band based on the different available bandwidths achieve an optimal power allocation and modulation order for the whole communication system including multiple moving UEs rather than a single UE.

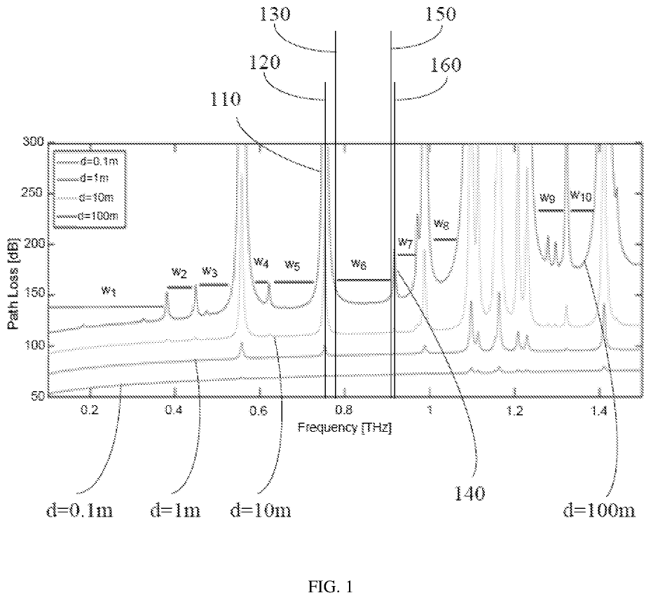

Due to the THz channel feature, an available band may be determined by the communication distance instead of being directly configured to UEs. FIG. 1 shows an example of a band of a transmission window in THz band to which the example embodiments of the present disclosure may be implemented. In the FIG. 1, the path loss in dB is shown for different transmission distances, for a standard atmosphere with 40% humidity. For transmission distances below one meter, where the number of water vapor molecules found along the path is small, the THz band behaves as a single transmission window several THz wide. As the transmission distance increases, for example, for the distance of 100 meters, molecular absorption lines define multiple transmission sub-windows, such as w₁, w₂, . . . wₙ, where n may be any integer, and any part or all of the sub-windows may be examples of available bandwidths. As is shown in the FIG. 1, an absorption line may form a parabola with one peak and two falling edges. For example, the single transmission sub-window w₆ is between an absorption line 110 and an absorption line 140. The absorption line 110 has an absorption line center 120, which is at the peak of the absorption line 110. The absorption line 140 has an absorption line center 160, which is at the peak of the absorption line 140. For the single transmission sub-window w₆, the absorption line 110 has a falling edge 130 and the absorption line 140 has a falling edge 150. The band between the falling edge 130 and the falling edge 150 may be briefly deemed as the available bandwidth of the transmission sub-window w₆.

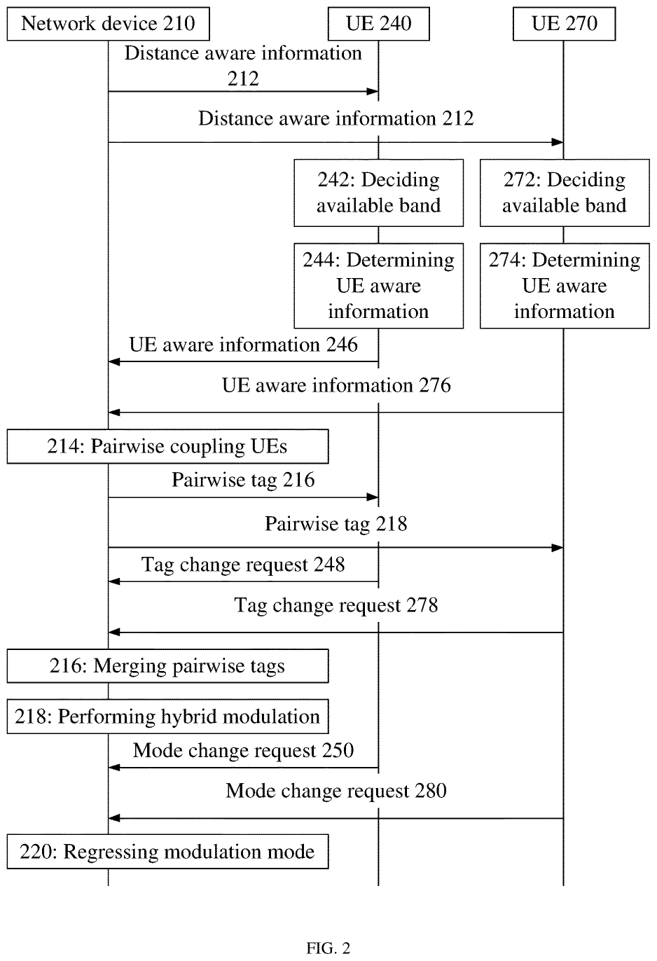

FIG. 2 shows an exemplary sequence diagram for a mechanism of the hybrid adaptive modulation mode according to example embodiments of the present disclosure. Referring to the FIG. 2, a network device 210 may represent the network side, e.g., in a base station (BS) or may function as the BS, such as evolved node B (eNB) or next generation node B (gNB), etc. The network device 210 may serve a plurality of terminal devices, and a UE 240 and a UE 270 may represent any of the plurality of terminal devices. The hybrid adaptive modulation mode according to embodiments of the present disclosure may be distance and frequency dependent, and the UE 240 may represent a UE closer than the UE 270 to the network device 210, and accordingly the UE 270 may represent a UE farther than the UE 240 to the network device 210.

The network device 210 may transmit to a plurality of UEs, distance aware information 212 reserved in e.g. a local directory of the network device 210. The distance aware information 212 may include a distance-bandwidth mapping table, which may be used by a UE to decide an available bandwidth based on the positioning information of the UE. In some example embodiments, the network device 210 may transmit the distance aware information 212 to the plurality of UEs, respectively. Alternatively, in some example embodiments, the network device 210 may transmit the distance aware information 212 to the plurality of UEs by e.g. broadcasting.

For a single transmission sub-window, such as the sub-windows shown in the FIG. 1, the distance-bandwidth mapping table may include, for example, the following: total frequency bandwidth and multiple transmission sub-windows: the lower and higher absorption line center frequencies in the single transmission sub-window; the differential frequencies between the higher/lower absorption line center frequencies (the peak of the parabola) and the falling edges of the parabola at the higher/lower absorption line, denoted as Δf^{up}, Δf^{down}; gNB positioning information, including e.g. ephemeris; the distance range and granularity, for example range from 1 m~100 m with granularity of 1 m; humidity; pressure; other relevant parameters at the single sub-window.

If the UE 240 or the UE 270 has global navigation satellite system (GNSS) ability, the UE 240 or the UE 270 may acquire the position fix. Alternatively, if the UE 240 or the UE 270 has no GNSS ability, the UE 240 or the UE 270 may acquire the positioning information from other device, e.g. provided by the network device 210. Receiving the distance aware information 212, in an operation 242, the closer UE 240 may decide an available bandwidth based on the distance-bandwidth mapping table. Similarly, receiving the distance aware information 212, in an operation 272, the farther UE 270 may decide an available bandwidth based on the distance-bandwidth mapping table.

In a case where there are more than one bandwidths available, for example, in the operation 272, the farther UE 270 finds that more than one bandwidths available, e.g. both w₄ and w₅ shown in the FIG. 1 are available based on the distance-bandwidth mapping table, the operation 272 may include an operation of selecting one sub-bandwidth from the more than one bandwidths as the decided available bandwidth. For example, in this case, the farther UE 270 may randomly select w₄ or w₅ as its decided available bandwidth. Alternatively, in this case, the farther UE 270 may select the relatively wider sub-window w₅ as its decided available bandwidth.

Then, in an operation 244, the closer UE 240 may determine its terminal aware information 246, and similarly, in an operation 274, the farther UE 270 may determine its terminal aware information 276. The terminal aware information could also be referred to as UE aware information. In some embodiments, the UE aware information 246/276 includes positioning information of the UE 240/270 and channel state information (CSI) of the UE 240/270, and optionally information on the available bandwidth of the UE 240/270. Then, the closer UE 240 may transmit the UE aware information 246 to the network device 210, and the farther UE 270 may transmit the UE aware information 276 to the network device 210.

Receiving from at least part of the plurality of UEs, respective UE aware information, in an operation 214, the network device 210 may pairwise couple the at least part of the plurality of terminal devices based on the respective UE aware information to form one or more pairs of UEs, and a pair of UEs may include a closer UE and a farther UE. For example, in a case where the network device 210 transmits the distance aware information 212 to 100 UEs, it is possible that the network device 210 receives the UE aware information from a part, e.g. 80 UEs out of the 100 UEs. In this case, the network device 210 may pairwise couple the part i.e. 80 UEs to form e.g. 40 pairs of UEs.

In some embodiments, the network device 210 may perform equidistant differential pairing through which the plurality of discrete UEs with different locations may be integrated into a radius centered on the network device 210, and the network device 210 may couple a closer UE and a farther UE to be a pair. For example, assuming there are 100 UEs labeled as UE1, UE2, . . . . UE100 in a distance ascending order, the network device 210 may couple UE1 and UE51 to be a pair, couple UE2 and UE52 to be a pair, . . . , and couple UE50 and UE 100 to be a pair. In a case where at least one UE of the plurality of UEs is movable, the pairwise coupling may be dynamically changing.

Alternatively or additionally, in some embodiments, the pairwise coupling can be based on the location/positioning information of the UEs, the path loss, reference signal receiving power (RSRP), reference signal receiving quality (RSRQ), and/or received signal strength indicator (RSSI).

Assuming in the operation 214, the network device 210 pairwise couples the closer UE 240 and the farther UE 270 to be a pair, in this case, the network device 210 may transmit a pairwise tag 216 to the closer UE 240 and transmit a pairwise tag 218 to the farther UE 270. In some embodiments, the pairwise tag may include the UE aware information of the paired UE. For example, the pairwise tag 216 may include the UE aware information 276 of the paired UE 270, and the pairwise tag 218 may include the UE aware information 246 of the paired UE 240. For example, the pairwise tag 216 may include signal quality, CSI, location etc. of the UE 270, and the pairwise tag 218 may include signal quality, CSI, location etc. of the UE 240. Alternatively, in some embodiments, the pairwise tag may include the UE aware information of both the UEs in the pair. In this case, either of the pairwise tag 216 and the pairwise tag 218 may include both the UE aware information 246 and the UE aware information 276.

On the UE side, in a case where a UE has sidelink capability and the sidelink is enabled, if two UEs are closely enough, one UE can monitor the neighboring UE's pairwise tag. For example, at least one UE of the plurality of UEs may be movable, thus, it is possible that the closer UE 240 or the farther UE 270 monitors the pairwise tag of a neighboring UE. In this case, the closer UE 240 or the farther UE 270 may transmit to the network device 210, a tag change request 248 or a tag change request 278. The tag change request 248 or 278 may include the UE aware information of the neighboring UE and may inform the network device 210 to carry out a reallocation of the pairwise tags.

In case of receiving from the closer UE 240 or the farther UE 270 of the pair of the closer UE 240 and the farther UE 270, the tag change request 248 or 278, in an operation 216, the network device 210 may merge the pairwise tag of the closer UE 240 or the farther UE 270 with the pairwise tag of the neighboring UE. Thus, in the following hybrid modulation operation, the closer UE 240 or the farther UE 270 with its neighboring UE may be treated equally. In a case the closer UE 240 or the farther UE 270 cannot monitor its neighboring UE, which may means the previous neighboring UE is not close enough to the closer UE 240 or the farther UE 270. In this case, the closer UE 240 or the farther UE 270 may send a tag change request to the network device 210. Receiving such a tag change request, the network device 210 may demerge the pairwise tag of the closer UE 240 or the farther UE 270 with the pairwise tag of the previous neighboring UE. Thus, in the following hybrid modulation operation, the closer UE 240 or the farther UE 270 with its previous neighboring UE may be treated separately.

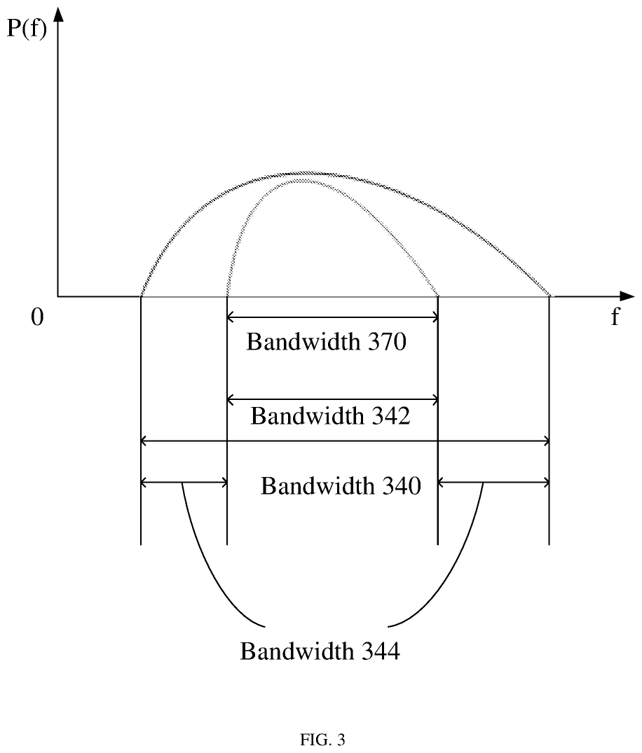

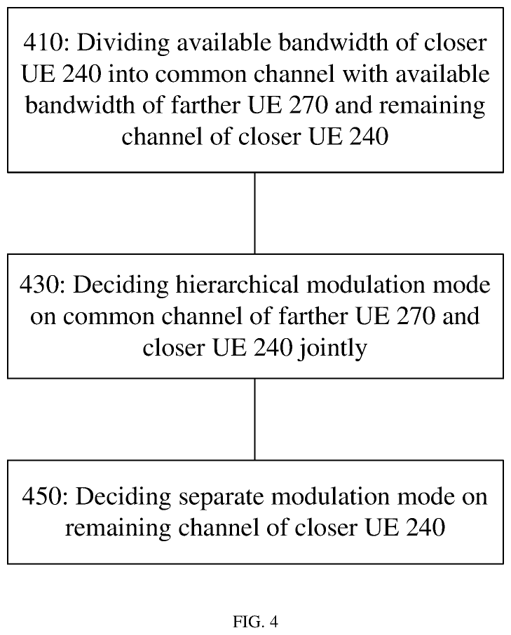

In an operation 218, the network device 210 may perform a hybrid modulation mode for the one or more pairs of UEs, respectively. The hybrid modulation mode may include a hierarchical type modulation and another type modulation. The hierarchical type modulation may be, for example, a hierarchical modulation (HM), a hierarchical bandwidth modulation (HBM), etc. The another type modulation may be, for example, a quadrature amplitude modulation (QAM), which may also be referred to as M-ary QAM (MQAM). The hybrid modulation mode may be, for example, termed as HM-QAM mode or HM-QAM strategy. The detail of the performance of hybrid modulation mode will be described later with respective to FIG. 3 and FIG. 4.

In some embodiments, the closer UE 240 or the farther UE 270 may measure and keep monitoring the channel condition. In a case where the closer UE 240 or the farther UE 270 fails to support a current modulation mode, for example, the closer UE 240 or the farther UE 270 cannot support the hybrid modulation mode, the closer UE 240 or the farther UE 270 may transmit to the network device 210, a mode change request 250 or a mode change request 280 for regressing to a secondary modulation mode.

In case of receiving from the closer UE 240 or the farther UE 270 of the pair of the closer UE 240 and the farther UE 270, the mode change request 250 or 280, in an operation 220, the network device 210 may regress the hybrid modulation mode to the hierarchical type modulation for the pair of the closer UE 240 and the farther UE 270. For example, in a case where either the closer UE 240 or the farther UE 270 transmits to the network device 210, the mode change request 250 or the mode change request 280, the network device 210 may regress the HM-QAM mode to the HM mode or the HBM mode for the closer UE 240 and the farther UE 270.

FIG. 3 shows an example scenario to which the example embodiments of the hybrid modulation mode according to the present disclosure may be implemented. Referring to the FIG. 3, the abscissa axis f denotes the frequency, and the longitude axis P (f) denotes the transmit power P on the frequency f. Still take the closer UE 240, the farther UE 270, and the network device 210 as example. The bandwidth 370 is the available bandwidth of the farther UE 270, and the bandwidth 340 is the available bandwidth of the closer UE 240. Thus, the bandwidth 340 may include a bandwidth 342 common to the bandwidth 370, and a remaining bandwidth 344.

FIG. 4 shows an exemplary flow diagram for performing the hybrid modulation mode according to example embodiments of the present disclosure. The operations shown in the FIG. 4 may be performed by the network device 210 in the operation 218.

Referring to the FIG. 4, in an operation 410, the network device 210 may divide the available bandwidth 340 of the closer UE 240 into a common channel h₁ with the available bandwidth of the farther UE 270 and a remaining channel h₃ of the closer UE 240. The common channel of the farther UE 270 may be denoted as h₂. The channel h₁ has the bandwidth 342, the channel h₂ has the bandwidth 370, and the channel h₃ has the bandwidth 344. For brevity, it is assumed that the bandwidth 340 is B1, the bandwidth 342/370 is B, and B1=2B, thus the remaining bandwidth 344 is B.

In an operation 430, the network device 210 may decide a hierarchical modulation mode on the common channel of the farther UE 270 and the closer UE 240 jointly. And in an operation 450, the network device 210 may decide a separate modulation mode on the remaining channel of the closer UE 240. For example, in the operation 430, the network device 210 may carry out HM mode on the overlapped frequency i.e. common frequency h₁, h₂ between the closer UE 240 and farther UE 270 and in the operation 450, the network device 210 may carry out QAM mode on the remaining frequency h₃ of closer UE 240. The HM-QAM mode may be formulated as the following formula (1), in which the HM-QAM mode is labelled as HM QAM

$$HM\_QAM : {max}_{{M}_{1} , {M}_{2} , {P}_{1} , {P}_{2}} {\underbrace{B {log}_{2} {M}_{1}}}_{farther UE on common frequency} + {\underbrace{B {log}_{2} {M}_{2}}}_{closer UE on common frequency} + {\underbrace{B {log}_{2} {M}_{3}}}_{closer UE on remaining frequency} \qquad ( 1 )$$

$$s . t .$$

$$C 1 : {M}_{1} \leq 1 + \frac{- 1.5}{{log}_{2} 5 {P}_{b , 1}} \frac{{P}_{2} {\vert {h}_{2} \vert}^{2}}{{N}_{0} B}$$

$$C 2 : {M}_{2} \leq 1 + \frac{- 1.5}{{log}_{2} 5 {P}_{b , 2}} ( \frac{{P}_{2} {\vert {h}_{1} \vert}^{2}}{{P}_{1} {\vert {h}_{1} \vert}^{2} + {N}_{0} B} + \frac{{P}_{1} {\vert {h}_{1} \vert}^{2}}{{N}_{0} B} + \frac{- 1.5}{{log}_{2} 5 {P}_{b , 2}} \frac{{P}_{1} {\vert {h}_{1} \vert}^{2}}{{N}_{0} B} \frac{{P}_{2} {\vert {h}_{1} \vert}^{2}}{{P}_{1} {\vert {h}_{1} \vert}^{2} + {N}_{0} B} )$$

$$C 3 : {M}_{3} \leq 1 + \frac{- 1.5}{{log}_{2} 5 {P}_{b , 3}} \frac{{P}_{3} {\vert {h}_{3} \vert}^{2}}{{N}_{0} B}$$

$$C 4 : {P}_{1} + {P}_{2} + {P}_{3} \leq {P}_{total}$$

where C1 to C4 denotes four constraints, respectively, M₁ denotes a modulation order on the common frequency/channel h₂, M₂ denotes a modulation order on the common frequency/channel h₁, M₃ denotes a modulation order on the remaining frequency/channel h₃, P₁ denotes a transmit power on the common frequency/channel h₂, P₂ denotes a transmit power on the common frequency/channel h₁, P₃ denotes a transmit power on the remaining frequency/channel h₃, P_{Total} denotes a total transmit power of the network device 210,

$$\frac{max}{{M}_{1} , {M}_{2} , {P}_{1} , {P}_{2}}$$

denotes obtained values of M₁, M₂, P₁, P₂ when the latter item Blog₂M₁+Blog₂M₂+Blog₂M₃ is maximized, P_{b,1}, P_{b,2}, and P_{b,3} denote bit error rate (BER) of binary phase shift keying (BPSK) and P_{b,1}=P_{b,2}=P_{b,3}=10⁻³, and N₀ denotes a power spectral density of noise.

For the above optimization problem, when the inequality constraints C1, C2 and C3 take equality, the objective function is maximized and the maximal data rate R may be calculated by the following formula (2).

$$R = B {log}_{2} ( 1 + \frac{{P}_{2} {h}_{2}}{{N}_{0} B} \frac{- 1.5}{{log}_{2} 5 {P}_{b , 2}} ) + B {log}_{2} ( 1 + \frac{{P}_{2} {h}_{1}}{{P}_{1} {h}_{1} + {N}_{0} B} \frac{- 1.5}{{log}_{2} 5 {P}_{b , 1}} ) + B {log}_{2} ( 1 + \frac{{P}_{1} {h}_{1}}{{N}_{0} B} \frac{- 1.5}{{log}_{2} 5 {P}_{b , 1}} ) + B {log}_{2} ( 1 + \frac{{P}_{3} {h}_{3}}{{N}_{0} B} \frac{- 1.5}{{log}_{2} 5 {P}_{b , 3}} ) \qquad ( 2 )$$

When P₃=P_{Total}−P₁−P₂, the above optimization problem may be transformed into optimizing transmit powers P₁ and P₂ to maximize the data rate R.

Due to the following formula (3),

$$\frac{{d}^{2} R}{{dP}_{2}^{2}} = \frac{B}{ln 2} \frac{- {( \frac{{h}_{2}}{{N}_{0} B} \frac{- 1.5}{{log}_{2} 5 {P}_{b , 2}} )}^{2}}{{( 1 + \frac{{P}_{2} {h}_{2}}{{N}_{0} B} \frac{- 1.5}{{log}_{2} 5 {P}_{b , 2}} )}^{2}} + \frac{B}{ln 2} \frac{- {( \frac{{h}_{1}}{{P}_{1} {h}_{1} + {N}_{0} B} \frac{- 1.5}{{log}_{2} 5 {P}_{b , 1}} )}^{2}}{{( 1 + \frac{{P}_{2} {h}_{1}}{{P}_{1} {h}_{1} + {N}_{0} B} \frac{- 1.5}{{log}_{2} 5 {P}_{b , 1}} )}^{2}} + \frac{- {BP}_{2}}{ln 2} \frac{{( \frac{- 1.5}{{log}_{2} 5 {P}_{b , 3}} \frac{- {h}_{3}}{{N}_{0} B} )}^{2}}{{( 1 + \frac{( {P}_{total} - {P}_{1} - {P}_{2} ) {h}_{3}}{{N}_{0} B} \frac{- 1.5}{{log}_{2} 5 {P}_{b , 3}} )}^{2}} \leq 0 \qquad ( 3 )$$

by setting,

$$\frac{d R}{d {P}_{2}} = 0 ,$$

the optimal P₂ may be deduced to maximize the data rate R according to the following formula (4).

$$\frac{d R}{d {P}_{2}} = B \frac{\frac{{h}_{2}}{{N}_{0} B} \frac{- 1.5}{{log}_{2} 5 {P}_{b , 2}}}{( 1 + \frac{{P}_{2} {h}_{2}}{{N}_{0} B} \frac{- 1.5}{{log}_{2} 5 {P}_{b , 2}} ) ln 2} + B \frac{\frac{{h}_{2}}{{P}_{1} {h}_{1} + {N}_{0} B} \frac{- 1.5}{{log}_{2} 5 {P}_{b , 1}}}{( 1 + \frac{{P}_{2} {h}_{1}}{{P}_{1} {h}_{1} + {N}_{0} B} \frac{- 1.5}{{log}_{2} 5 {P}_{b , 1}} ) ln 2} + B \frac{\frac{- 1.5}{{log}_{2} 5 {P}_{b , 3}} \frac{- {h}_{3}}{{N}_{0} B}}{( 1 + \frac{( {P}_{t otal} - {P}_{1} - {P}_{2} ) {h}_{3}}{{N}_{0} B} \frac{- 1.5}{{log}_{2} 5 {P}_{b , 3}} ) ln 2} = 0 \qquad ( 4 )$$

By adopting an one-dimension search, the optimal transmit power P₁ can be obtained. An example process may be shown as the following Table 1.

TABLE 1
1-D search extreme point (SEP) process

Process: 1-D SEP workflow
Input: The THz channel power gain h₁, h₂, h₃ of the closer UE 240 and the farther UE
270 on the common frequency and closer UE 240 on the remaining frequency respectively.
The remaining frequency B, the available common bandwidth B of closer UE 240 and farther
UE 270, the total transmit power of the network device 210 Pₜₒₜₐₗ and iteration step size t.
$output : The optimal transmit power {P}_{1}^{*} , {P}_{2}^{*} , {P}_{3}^{*} , optimal modulation order$
${M}_{1}^{*} , {M}_{2}^{*} , {M}_{3}^{*} and maximal data rate {R}^{*} .$
Begin for the process P₁ = 0.01:t:Pₜₒₜₐₗ,
Obtain the optimal P₂ by deriving of R with respect to P₂.
Obtain the value of P₃ according to P₃ = Pₜₒₜₐₗ − P₁ − P₂
Substitute the obtained P₁, P₂ and P₃ into R to get the maximal data rate R.
Substitute the obtained P₁, P₂ and P₃ into M₁, M₂, and M₃ to get the optimal
modulation order.
End for the process.
$Obtain the final {R}^{*} according to max ( R ) and the corresponding the optimal {P}_{1}^{*} , {P}_{2}^{*} , {P}_{3}^{*} ,$
$modulation order {M}_{1}^{*} , {M}_{2}^{*} , {M}_{3}^{*} .$

According to the above example process, the hybrid modulation mode is carried out to obtain transmission powers for the common channel and the remaining channel of the closer UE 240 and the common channel of the farther UE 270, respectively, e.g. the optimal transmit power

$${P}_{2}^{*} , {P}_{3}^{*} , {P}_{1}^{*} ,$$

modulation orders for the common channel and the remaining channel of the closer UE 240 and the common channel of the farther UE 270, respectively, e.g. optimal modulation order

$${M}_{2}^{*} , {M}_{3}^{*} , {M}_{1}^{*} ,$$

and an expected data rate, e.g. the maximal data rate R* of the network device 210.

The pair of the farther UE 270 and the closer UE 240 may represent any pair of the one or more pair of UEs served by the network device 210. In other words, the network device 210 may perform the hybrid modulation mode for any of the one or more pair of UEs, either original or reallocated.

By using the above modulation mode, for the closer UE, the bandwidth could be divided into different part including common frequency part and the remaining frequency part and then different modulation strategies may be carried out to obtain a good system performance.

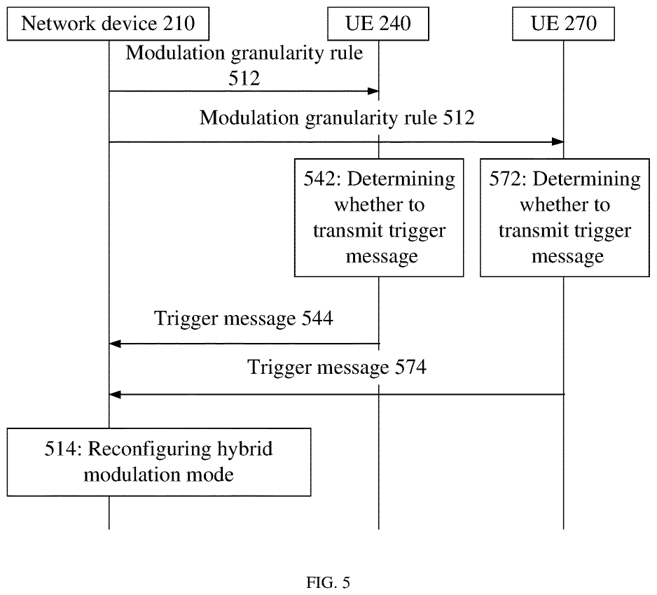

Because a UE may be movable, and/or the channel state e.g. signal to noise ratio (SNR) and/or the available bandwidth of the UE may be change, it is possible that the modulation mode needs to be reconfigured. For example, the parameters for the adaptive modulation are to be adjusted. FIG. 5 shows an exemplary sequence diagram for triggering the modulation mode reconfiguration according to example embodiments of the present disclosure. The operations shown in the FIG. 5 may be performed after, in parallel to, or partly before the operations in the FIG. 2.

Referring to the FIG. 5, the network device 210 may transmit to the plurality of UEs, a modulation granularity rule 512, which may be used by the respective UE to determine whether the modulation mode reconfiguration needs to be made. The network device 210 may transmit the modulation granularity rule 512 with the distance aware information 212. Alternatively, the network device 210 may transmit the modulation granularity rule 512 and the distance aware information 212 separately. In some example embodiments, the network device 210 may transmit the modulation granularity rule 512 to the plurality of UEs, respectively. Alternatively, in some example embodiments, the network device 210 may transmit the modulation granularity rule 512 to the plurality of UEs by e.g. broadcasting.

In case of receiving the modulation granularity rule 512, in an operation 542, the UE 240 may determine whether to transmit to the network device 210 a message to trigger the network device 210 to reconfigure a modulation mode, based on the received modulation granularity rule 512, and similarly in an operation 572, the UE 270 may determine whether to transmit to the network device 210 a message to trigger the network device 210 to reconfigure a modulation mode, based on the received modulation granularity rule 512.

In some embodiments, the modulation granularity rule 512 may be associated with the distance d between the UE 240/270 and the network device 210, the SNR and the available band B of the UE 240/270. An example modulation granularity rule 512 may be designed as the following Table 2, where the expression (d) refers to the value at the distance d. It is noted that the B relating to modulation mode adjustment represents an available band function of d and is different from the B in preceding formulas.

TABLE 2
Modulation granularity rule

| d | SNR | Available band | Adjust or not |
|---|---|---|---|
| Increase | ΔSNR ≥ 0.5 dB | Arbitrary | Adjust |
| (Δd > 0) | ΔSNR ≤ 0.5 dB | $\vert B ( d + Δ d ) - B ( d ) \vert \leq {min}_{m , n} ( Δ {f}_{m , n} ( d ) )$ | Not adjust |
| | | $\vert B ( d + Δ d ) - B ( d ) \vert \geq {min}_{m , n} ( Δ {f}_{m , n} ( d ) )$ | Adjust |
| Remain | ΔSNR ≥ 0.5 dB | unchanged | Adjust |
| unchanged | | | |
| (Δd = 0) | ΔSNR ≤ 0.5 dB | unchanged | Not adjust |
| Decrease | ΔSNR ≥ 0.5 dB | Arbitrary | Adjust |
| (Δd < 0) | | | |
| | ΔSNR ≤ 0.5 dB | $\vert B ( d + Δ d ) - B ( d ) \vert \leq {min}_{m , n} ( Δ {f}_{m , n} ( d ) )$ | Not adjust |
| | | $\vert B ( d + Δ d ) - B ( d ) \vert \geq {min}_{m , n} ( Δ {f}_{m , n} ( d ) )$ | Adjust |

Under the above modulation granularity rule, when the UE 240/270 moves distance Δ d relative to a previous distance d during time Δ t from a previous time t, the probability of SNR difference no smaller than the threshold γₜₕ may be calculated as the following formula (5).

$$P = Pr ( \vert γ ( t ) - γ ( t + Δ t ) \vert \geq {γ}_{th} ) = Pr ( \vert \frac{1.5 {h}_{\text{?}}^{2} ( t , d ) {P}_{m , n} ( {γ}_{m , n} )}{- ln ( 5 {P}_{b , m , n} ) {N}_{0} Δ {f}_{m , n} ( d )} - \frac{1.5 {h}_{\text{?}}^{2} ( t + Δ t , d + Δ d ) {P}_{m , n} ( {γ}_{m , n} )}{- ln ( 5 {P}_{b , m , n} ) {N}_{0} Δ {f}_{m , n} ( d + Δ d )} \vert \geq {γ}_{th} ) = Pr ( \begin{matrix}( 1.5 {P}_{m , n} ( {γ}_{m , n} ) Δ {f}_{m , n} ( d + Δ d ) - 1.5 {f}_{m , n} ( d ) {P}_{m , n} ( {γ}_{m , n} ) ) {h}_{\text{?}}^{2} ( t , d ) - \\ 3 Δ {f}_{m , n} ( d ) {P}_{m , n} ( {γ}_{m , n} ) ε {h}_{\text{?}} ( t , d ) \geq - {γ}_{th} ln ( 5 {P}_{b , m , n} ) {N}_{0} Δ {f}_{m , n} ( d ) \\ Δ {f}_{m , n} ( d + Δ d ) + 1.5 Δ {f}_{m , n} ( d ) {ε}^{2} {P}_{m , n} ( {γ}_{m , n} )\end{matrix} ) + Pr ( \begin{matrix}( 1.5 {P}_{m , n} ( {γ}_{m , n} ) Δ {f}_{m , n} ( d + Δ d ) - 1.5 Δ {f}_{m , n} ( d ) {P}_{m , n} ( {γ}_{m , n} ) ) {h}_{\text{?}}^{2} ( t ) - \\ 3 Δ {f}_{m , n} ( d ) ε {P}_{m , n} ( {γ}_{m , n} ) {h}_{\text{?}} ( t , d ) \leq 1.5 Δ {f}_{m , n} ( d ) {ε}^{2} ( {γ}_{m , n} ) + \\ {γ}_{th} ln ( 5 {P}_{b , m , n} ) {N}_{0} Δ {f}_{m , n} ( d ) Δ {f}_{m , n} ( d + Δ d )\end{matrix} ) = {P}_{1} + {P}_{2} \qquad ( 5 )$$

$$\text{?} \text{indicates text missing or illegible when filed}$$

Where Pr represents probability function, Δf_{m,n} represents the subcarrier band of the n-th available subcarrier of the m-th sub-window, P_{m,n} represents the power allocation of the n-th available subcarrier of the m-th sub-window, h_{m,n} represents the CSI of the n-th available subcarrier of the m-th sub-window, γ_{m,n} represents the index m, n, P_{b,m,n} represents the BER requirement in the n-th available subcarrier of the m-th sub-window, N₀ represents the power spectral density of noise, γ is the SNR value, (t) represents the value at the time t, h(t+Δt,d+Δd)=h(t,d)+ε, h(t+Δt,d+Δd) and h(t,d) denote the channel power gain at the distance d+Δd and time t+Δt as well as distance d and time t, respectively. h(t,d) and ε are independent of each other, and

$$ε \sim N ( 0 , {σ}_{n}^{2} ) ,$$

where

$$\begin{matrix}P = Pr ( \vert γ ( t ) - γ ( t + Δ t ) \vert \geq {γ}_{th} ) \\ = Pr ( \vert \frac{1.5 {h}_{m , n}^{2} ( t , d ) {P}_{m , n} ( {γ}_{m , n} )}{- ln ( 5 {P}_{b , m , n} ) {N}_{0} Δ {f}_{m , n} ( d )} - \\ \frac{1.5 {h}_{m , n}^{2} ( t + Δt , d + Δ d ) {P}_{m , n} ( {γ}_{m , n} )}{- ln ( 5 {P}_{b , m , n} ) {N}_{0} Δ {f}_{m , n} ( d + Δ d )} \vert \geq {γ}_{th} ) \\ = Pr ( \begin{matrix}( 1.5 {P}_{m , n} ( {γ}_{m , n} ) Δ {f}_{m , n} ( d + Δ d ) - 1.5 Δ {f}_{m , n} ( d ) {P}_{m , n} ( {γ}_{m , n} ) ) {h}_{m , n}^{2} \\ ( t , d ) - 3 Δ {f}_{m , n} ( d ) {P}_{m , n} ( {γ}_{m , n} ) ε {h}_{m , n} ( t , d ) \geq - {γ}_{th} ln ( 5 {P}_{b , m , n} ) \\ {N}_{0} Δ {f}_{m , n} ( d ) Δ {f}_{m , n} ( d + Δ d ) + 1.5 Δ {f}_{m , n} ( d ) {ε}^{2} {P}_{m , n} ( {γ}_{m , n} )\end{matrix} ) + \\ Pr ( \begin{matrix}( 1.5 {P}_{m , n} ( {γ}_{m , n} ) Δ {f}_{m , n} ( d + Δ d ) - 1.5 Δ {f}_{m , n} ( d ) {P}_{m , n} ( {γ}_{m , n} ) ) {h}_{m , n}^{2} \\ ( t ) - 3 Δ {f}_{m , n} ( d ) ε {P}_{m , n} ( {γ}_{m , n} ) {h}_{m , n} ( t , d ) \leq 1.5 Δ {f}_{m , n} ( d ) {ε}^{2} {P}_{m , n} \\ ( {γ}_{m , n} ) + {γ}_{th} ln ( 5 {P}_{b , m , n} ) {N}_{0} Δ {f}_{m , n} ( d ) Δ {f}_{m , n} ( d + Δ d )\end{matrix} ) \\ = {P}_{1} + {P}_{2}\end{matrix}$$

is the variance of the error variable. It is noted that the P₁ and P₂ representing probabilities in the formula (5) and following formulas are different from P₁ and P₂ relating to the transmit power in preceding formulas.

Auxiliary parameters expressed as the following formula (6) may be introduced for calculating probability of adjusting the modulation mode in different scenarios.

$$\{ \begin{matrix}A = 1.5 {P}_{m , n} ( {γ}_{m , n} ) ( Δ {f}_{m , n} ( d + Δ d ) - Δ {f}_{m , n} ( d ) ) \\ B = 3 Δ {f}_{m , n} ( d ) {P}_{m , n} ( {γ}_{m , n} ) ε \\ C = - {γ}_{th} ln ( 5 {P}_{b , m , n} ) {N}_{0} Δ {f}_{m , n} ( d ) Δ {f}_{m , n} ( d + Δ d ) + \\ 1.5 Δ {f}_{m , n} ( d ) {ε}^{2} {P}_{m , n} ( {γ}_{m , n} ) \\ C 2 = 1.5 Δ {f}_{m , n} ( d ) {ε}^{2} {P}_{m , n} ( {γ}_{m , n} ) + {γ}_{th} ln ( 5 {P}_{b , m , n} ) {N}_{0} Δ {f}_{m , n} ( d ) Δ {f}_{m , n} ( d + \\ Δ d ) \\ Δ = {B}^{2} - 4 A C \\ = 6 {P}_{m , n} ( {γ}_{m , n} ) Δ {f}_{m , n} ( d ) Δ {f}_{m , n} ( d + Δ d ) [ {γ}_{th} ln ( 5 {P}_{b , m , n} ) {N}_{0} ( Δ {f}_{m , n} ( d ) - \\ Δ {f}_{m , n} ( d + Δ d ) ) + 1.5 {ε}^{2} {P}_{m , n} ( {γ}_{m , n} ) ] \\ Δ 2 = {B}^{2} - 4 A C 2 \\ = 6 {P}_{m , n} ( {γ}_{m , n} ) Δ {f}_{m , n} ( d ) Δ {f}_{m , n} ( d + Δ d ) [ {γ}_{th} ln ( 5 {P}_{b , m , n} ) {N}_{0} \{ Δ {f}_{m , n} ( d + \\ Δ d ) - Δ {f}_{m , n} ( d ) \} + 1.5 {ε}^{2} {P}_{m , n} ( {γ}_{m , n} ) ]\end{matrix} \qquad ( 6 )$$

The first scenario: Δd>0, Δf_{m,n}(d)−Δf_{m,n}(d+Δd)>0, A<0, C>0, Δ2>0.

The calculation of P₁ may be performed as following:

when Δ≤0, P₁=0; and
when Δ>0, h_{m,n}>0, P₁=Pr(h_{m,n}>0)=1−Fₕ_{_{m,n}}(0), where Fₕ_{_{m,n}} is the cumulative density function (CDF) of h_{m,n}.

The calculation of P₂ may be performed as following:

when C2>0, h_{m,n}>0, P₂=1; and
When C2<0, ε satisfies

$$- \sqrt{\frac{- {γ}_{th} ln ( 5 {P}_{b , m , n} ) {N}_{0} Δ {f}_{m , n} ( d ) Δ {f}_{m , n} ( d + Δ d )}{1.5 Δ {f}_{m , n} ( d ) {P}_{m , n} ( {γ}_{m , n} )}} < ε < \sqrt{\frac{- {γ}_{th} ln ( 5 {P}_{b , m , n} ) {N}_{0} Δ {f}_{m , n} ( d ) Δ {f}_{m , n} ( d + Δ d )}{1.5 Δ {f}_{m , n} ( d ) {P}_{m , n} ( {γ}_{m , n} )}}$$

and h_{m,n} meets

$${h}_{m , n} > \frac{B - \sqrt{{B}^{2} + 4 A C 2}}{2 A} ,$$

P₂ may thus be calculated as the following formula (7).

$$\begin{matrix}{P}_{2} = Pr ( {h}_{m , n} > \frac{B - \sqrt{{B}^{2} + 4 A C 2}}{2 A} ) \\ = {{\int }_{- \sqrt{\frac{- {γ}_{th} ln ( 5 {P}_{b , m , n} ) {N}_{0} Δ {f}_{m , n} ( d + Δ d )}{1.5 {P}_{m , n} ( {γ}_{m , n} )}}}}^{\sqrt{\frac{- {γ}_{th} ln ( 5 {P}_{b , m , n} ) {N}_{0} Δ {f}_{m , n} ( d + Δ d )}{1.5 {P}_{m , n} ( {γ}_{m , n} )}}} ( 1 - \\ {F}_{{h}_{m , n}} ( \frac{B - \sqrt{{B}^{2} + 4 A C 2}}{2 A} ) ) {f}_{ε} ( ε ) d ε\end{matrix} \qquad ( 7 )$$

where f_{ε}(ε)dε is the probability density function (PDF) of the channel error variable.

To sum up, the total probability Pₜₒₜₐₗ of adjusting the modulation mode under the first scenario may be written as the following formula (8). It is noted that the Pₜₒₜₐₗ representing the total probability in the formula (8) and following formulas are different from Pₜₒₜₐₗ relating to the transmit power in preceding formulas.

$${P}_{total} = {P}_{1} + {P}_{2} + \frac{1}{2} ( 1 - {P}_{1} - {P}_{2} ) \qquad ( 8 )$$

The second scenario: Δd<0, Δf_{m,n}(d)−Δf_{m,n}(d+Δd)<0, A>0, C>0, Δ>0.

The calculation of P₁ may be performed as following:

When h_{m,n} meets

$${h}_{m , n} \geq \frac{B + \sqrt{{B}^{2} + 4 A C}}{2 A} ,$$

P₁ may be calculated as the following formula (9).

$${P}_{1} = Pr ( {h}_{m , n} \geq \frac{B + \sqrt{{B}^{2} + 4 A C}}{2 A} ) = {\int }_{- ∞}^{+ ∞} ( 1 - {F}_{{h}_{m , n}} ( \frac{B + \sqrt{{B}^{2} + 4 A C}}{2 A} ) {f}_{ε} ( ε ) d ε \qquad ( 9 )$$

The calculation of P₂ may be performed as following:
a. when C2>0, and Δ2>0, ε satisfies the following formula (10).

$$- ∞ < ε < - \sqrt{\frac{- {γ}_{th} ln ( 5 {P}_{b , m , n} ) {N}_{0} Δ {f}_{m , n} ( d + Δ d )}{1.5 {P}_{m , n} ( {γ}_{m , n} )}} and \\ \sqrt{\frac{- {γ}_{th} ln ( 5 {P}_{b , m , n} ) {N}_{0} Δ {f}_{m , n} ( d + Δ d )}{1.5 {P}_{m , n} ( {γ}_{m , n} )}} < ε < + ∞ \qquad ( 10 )$$

Therefore, P₂ may be calculated as the following formula (11).

$$\begin{matrix}{P}_{2} = Pr ( 0 < {h}_{m , n} < \frac{B + \sqrt{{B}^{2} + 4 A C 2}}{2 A} ) = \\ {\int }_{- ∞}^{+ ∞} {F}_{{h}_{m , n}} ( \frac{B + \sqrt{{B}^{2} + 4 A C 2}}{2 A} ) {f}_{ε} ( ε ) d ε \\ = {{\int }_{- ∞}}^{- \sqrt{\frac{- {γ}_{th} ln ( 5 {P}_{b , m , n} ) {N}_{0} Δ {f}_{m , n} ( d + Δ d )}{1.5 {P}_{m , n} ( {γ}_{m , n} )}}} {F}_{{h}_{m , n}} ( \frac{B + \sqrt{{B}^{2} + 4 A C 2}}{2 A} ) {f}_{ε} ( ε ) d ε + \\ {\int }_{\sqrt{\frac{- {γ}_{th} ln ( 5 {P}_{b , m , n} ) {N}_{0} Δ {f}_{m , n} ( d + Δ d )}{1.5 {P}_{m , n} ( {γ}_{m , n} )}}}^{+ ∞} {F}_{{h}_{m , n}} ( \frac{B + \sqrt{{B}^{2} + 4 A C 2}}{2 A} ) {f}_{ε} ( ε ) d ε\end{matrix} \qquad ( 11 )$$

b. when C2>0, and Δ2≤0, P₂₌₀.
c. when C2<0, Δ2>0, and ε meets the following formulas (12) and (13),

$$\sqrt{\frac{{γ}_{th} ln ( 5 {P}_{b , m , n} ) {N}_{0} \{ Δ {f}_{m , n} ( d + Δ d ) - Δ {f}_{m , n} ( d ) \}}{- 1.5 {P}_{m , n} ( {γ}_{m , n} )}} < ε < \sqrt{\frac{- {γ}_{th} ln ( 5 {P}_{b , m , n} ) {N}_{0} Δ {f}_{m , n} ( d + Δ d )}{1.5 {P}_{m , n} ( {γ}_{m , n} )}} \qquad ( 12 )$$

$$- \sqrt{\frac{- {γ}_{th} ln ( 5 {P}_{b m n} ) {N}_{0} Δ {f}_{m n} ( d + Δ d )}{1.5 {P}_{m , n} ( {γ}_{m , n} )}} < ε < - \sqrt{\frac{{γ}_{th} ln ( 5 {P}_{b , m , n} ) {N}_{0} \{ Δ {f}_{m , n} ( d + Δ d ) - Δ {f}_{m , n} ( d ) \}}{- 1.5 {P}_{m , n} ( {γ}_{m , n} )}} \qquad ( 13 )$$

the following formula (14) may be obtained.

$$0 < \frac{B - \sqrt{{B}^{2} + 4 A C 2}}{2 A} < {h}_{m , n} < \frac{B + {B}^{2} + 4 A C 2}{2 A} \qquad ( 14 )$$

In this case P₂ may be calculated as the following formula (15).

$$\begin{matrix}{P}_{2} = Pr ( \frac{B - \sqrt{{B}^{2} + 4 A C 2}}{2 A} < {h}_{m , n} < \frac{B + \sqrt{{B}^{2} + 4 A C 2}}{2 A} ) \\ = {\int }_{∞}^{+ ∞} [ {F}_{{h}_{m , n}} ( \frac{B + \sqrt{{B}^{2} + 4 A C 2}}{2 A} ) - {F}_{{h}_{m , n}} \\ ( \frac{B - \sqrt{{B}^{2} + 4 A C 2}}{2 A} ) ] {f}_{ε} ( ε ) d ε \\ = {{\int }_{- \sqrt{\frac{- {γ}_{th} ln ( 5 {P}_{b , m , n} ) {N}_{0} Δ {f}_{m , n} ( d + Δ d )}{1.5 {P}_{m , n} ( {γ}_{m , n} )}}}}^{- \sqrt{\frac{{γ}_{th} ln ( 5 {P}_{b , m , n} ) {N}_{0} \{ Δ {f}_{m , n} ( d + Δ d ) - Δ {f}_{m , n} ( d ) \}}{1.5 {P}_{m , n} ( {γ}_{m , n} )}}} [ {F}_{{h}_{m , n}} \\ ( \frac{B + \sqrt{{B}^{2} + 4 A C 2}}{2 A} ) - {F}_{{h}_{m , n}} ( \frac{B - \sqrt{{B}^{2} + 4 A C 2}}{2 A} ) ] {f}_{ε} ( ε ) d ε + \\ {{\int }_{\sqrt{\frac{{γ}_{th} ln ( 5 {P}_{b , m , n} ) {N}_{0} \{ Δ {f}_{m , n} ( d + Δ d ) - Δ {f}_{m , n} ( d ) \}}{1.5 {P}_{m , n} ( {γ}_{m , n} )}}}}^{\sqrt{\frac{- {γ}_{th} ln ( 5 {P}_{b , m , n} ) {N}_{0} Δ {f}_{m , n} ( d + Δ d )}{1.5 {P}_{m , n} ( {γ}_{m , n} )}}} [ {F}_{{h}_{m , n}} \\ ( \frac{B + {B}^{2} + 4 A C 2}{2 A} ) - {F}_{{h}_{m , n}} ( \frac{B - \sqrt{{B}^{2} + 4 A C 2}}{2 A} ) ] {f}_{ε} ( ε ) d ε\end{matrix} \qquad ( 15 )$$

d. when C2<0 and Δ2≤0, P₂=0.

To sum up, the total probability Pₜₒₜₐₗ of adjusting the modulation mode under the second scenario may be written as the following formula (16).

$${P}_{total} = {P}_{1} + {P}_{2} + \frac{1}{2} ( 1 - {P}_{1} - {P}_{2} ) \qquad ( 16 )$$

The third scenario: Δd=0.

In this scenario, the adjustment probability of the modulation mode, due to the channel time-varying, may be calculated as the following formula (17).

$$\begin{matrix}P = Pr ( \vert γ ( t ) - γ ( t + Δ t ) \vert \geq {γ}_{th} ) = Pr ( \vert \frac{1.5 {h}_{m , n}^{2} ( t ) {P}_{m , n} ( {γ}_{m , n} )}{- ln ( 5 {P}_{b , m , n} ) {N}_{0} Δ {f}_{m , n}} - \\ \frac{1.5 {h}_{m , n}^{2} ( t + Δ t ) {P}_{m , n} ( {γ}_{m , n} )}{- ln ( 5 {P}_{b , m , n} ) {N}_{0} Δ {f}_{m , n}} \vert \geq {γ}_{th} ) \\ = {{\int }_{- ∞}}^{0} {F}_{{h}_{m , n}} ( \frac{ε}{- 2} + {γ}_{th} ln ( 5 {P}_{b , m , n} ) {N}_{0} \frac{Δ {f}_{m , n}}{1.5 {P}_{m , n} ( {γ}_{m , n} ) {h}_{l}^{2} 2 ε} ) \\ {f}_{ε} ( ε ) d ε + {{\int }_{- ∞}}^{- ∞} ( 1 - {F}_{{h}_{m , n}} ( - \frac{ε}{2} - {γ}_{th} ln ( 5 {P}_{b , m , n} ) \\ {N}_{0} \frac{Δ {f}_{m , n}}{1.5 {P}_{m , n} ( {γ}_{m , n} ) {h}_{l}^{2} 2 ε} ) ) {f}_{ε} ( ε ) d ε\end{matrix} \qquad ( 17 )$$

Where hₗ represents the path loss, h(t+Δt)=h(t)+ε, h(t) and ε are independent of each other, and

$$ε \sim N ( 0 , {σ}_{n}^{2} ) .$$

In a case where in the operation 542/572, the UE 240/270 determines that the modulation mode, e.g. the hybrid HB_QAM mode, needs to be reconfigured, the UE 240/270 may transmit to the network device 210 a trigger message 544/574.

In case of receiving from the closer UE 240 or the farther UE 270 of the pair of the closer UE 240 and the farther UE 270, the trigger message 544 or 574, in an operation 514, the network device 210 may reconfigure the hybrid modulation mode for the pair of the closer UE 240 and the farther UE 270. For example, the network device 210 may adjust the parameters for the hybrid modulation mode.

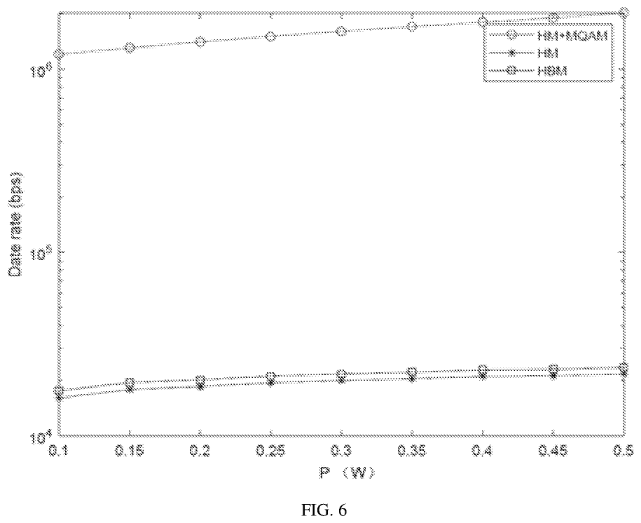

FIG. 6 shows simulation curves of the data rate according to different modulation modes. Referring to the FIG. 6, the horizontal axis P(W) refers to the total power Pₜₒₜₐₗ, the vertical axis refers to the data rate in terms of bits per second (bps). From FIG. 6, it can be seen that the data rate of the hybrid HM−QAM mode, labeled as HM+HQAM in the FIG. 6, is higher than that of the other two modulation modes, HM and HBM. The data rate of HBM is higher than HM.

FIG. 7 shows simulation curves of the modulation orders according to different modulation modes. Referring to the FIG. 7, the horizontal axis P(W) refers to the total power Pₜₒₜₐₗ, the vertical axis refers to the modulation order. M1 refers to the modulation order on the common available bandwidth of the farther UE, M2 refers to the modulation order on the common available bandwidth of the closer UE, and M3 refers to the modulation order on the remaining available bandwidth of the closer UE. The hybrid HM−QAM mode is labeled as HM+HQAM in the FIG. 7. From the FIG. 7, it can be seen that the modulation order M2 of the closer UE on the overlapped frequency band is higher than the modulation order M3 of the closer UE on the remaining frequency band. The modulation order M1 of the farther UE is approximately equal to the modulation order M3 of the closer UE on the remaining frequency band. The modulation order of the closer UE is higher than that of farther UE under the HBM and HM modes. The example embodiments of the present disclosure achieves an optimal power allocation and modulation order for the whole communication system including multiple moving UEs rather than a single UE.

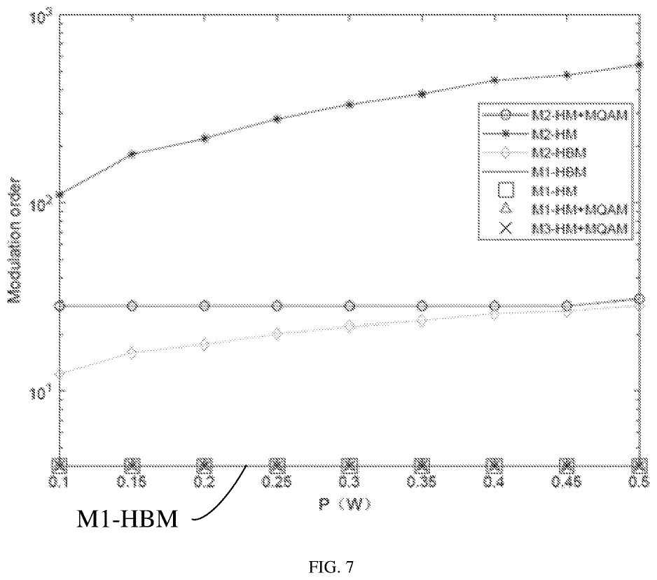

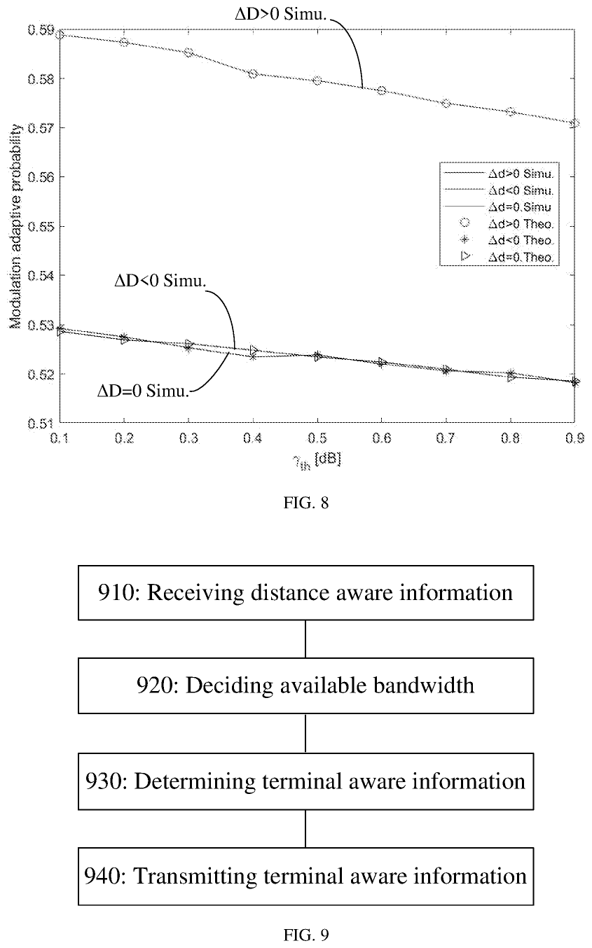

FIG. 8 shows simulation curves of the probabilities that the modulation mode is adjusted according to example embodiments of the present disclosure. In the FIG. 8, the Simu. refers to the result acquired through simulation, and the Theo. refers to the theoretical result. The horizontal axis γₜₕ[dB] refers to the adjustment threshold in terms of SNR in unit of dB, and the vertical axis Modulation adaptive probability refers to the probabilities that the p modulation mode is adjusted, for example, the parameters for the hybrid modulation mode are adjusted.

The FIG. 8 shows that the farther the UE moves from the BS, the greater the probability of modulation mode adjustment. When the UE is stationary or close to the BS, the probability of adjustment is basically the same. At the same time, it can be seen that the higher the adjustment threshold is, the lower the adjustment probability is, because when the adjustment granularity become larger, the channel variation and distance variation that meet the conditions are getting wider, and thus the adjustment probability is becoming lower.

The hybrid modulation mode, e.g. the hybrid HM_MQAM mode, according to the example embodiments of the present disclosure are suitable for the multi-UE case. By adopting the hierarchical type modulation on the overlapped frequency between the farther and closer UEs and the another type modulation, e.g. QAM, on the remaining frequency at the closer UE, a joint performance results of the farther UE and the closer UE may be achieved. The results show that the modulation order on the resultant frequencies of the closer UE is different from that on the overlapped frequencies. The data rate of the proposed hybrid modulation mode is higher than that of the HBM and HM modes.

The example embodiments of the present disclosure are suitable for the mobility of the UEs and the adjustment rule of the modulation mode is proper for the moving UE. The adjustment probability may be derived, based on which, the modulation adjustment probability of the UE moving farther from the BS is higher due to the varying channel and distance-dependent available bandwidth. In the case of multi-UE, the example embodiments of the present disclosure provides the hybrid modulation mode, e.g. the HM−QAM mode, for the THz communication and the simulation results show the superiority compared to the other modulation modes.

FIG. 9 shows a flow chart illustrating an example method 900 for terahertz channel communication according to the example embodiments of the present disclosure. The example method 900 may be performed for example by a terminal device for communication such as the UE 240 or 270.

Referring to the FIG. 9, the example method 900 may include an operation 910 of receiving from a serving network device, distance aware information comprising a distance-bandwidth mapping table; an operation 920 of deciding an available bandwidth based on the distance-bandwidth mapping table; an operation 930 of determining terminal aware information of the terminal device; and an operation 940 of transmitting to the serving network device, the terminal aware information, wherein the terminal aware information comprises positioning information and channel state information, and optionally information on the available bandwidth.

Details of the operation 910 have been described in the above descriptions with respect to at least the distance aware information 212, and repetitive descriptions thereof are omitted here.

Details of the operation 920 have been described in the above descriptions with respect to at least the operations 242 and 272, and repetitive descriptions thereof are omitted here.

Details of the operation 930 have been described in the above descriptions with respect to at least the operations 244 and 274, and repetitive descriptions thereof are omitted here.

Details of the operation 940 have been described in the above descriptions with respect to at least the UE aware information 246 and 276, and repetitive descriptions thereof are omitted here.

In some example embodiments, in a case where there are more than one bandwidths available, the deciding of the available bandwidth may comprise: selecting one sub-bandwidth from the more than one bandwidths as the decided available bandwidth. The more details have been described in the above descriptions with respect to at least the operations 242 and 272, and repetitive descriptions thereof are omitted here.

In some example embodiments, the example method 900 may further include an operation of receiving from the serving network device, a pairwise tag comprising terminal aware information of a paired terminal device. The more details have been described in the above descriptions with respect to at least the pairwise tags 216 and 218, and repetitive descriptions thereof are omitted here.

In some example embodiments, the example method 900 may further include an operation of transmitting to the serving network device, a tag change request in case of monitoring a pairwise tag of a neighboring terminal device. The more details have been described in the above descriptions with respect to at least the tag change requests 248 and 278, and repetitive descriptions thereof are omitted here.

In some example embodiments, in a case where the terminal device fails to support a current modulation mode, the example method 900 may further include an operation of transmitting to the serving network device, a mode change request for regressing to a secondary modulation mode. The more details have been described in the above descriptions with respect to at least the mode change requests 250 and 280, and repetitive descriptions thereof are omitted here.

In some example embodiments, in case of receiving from the serving network device, a modulation granularity rule, the example method 900 may further include an operation of determining whether to transmit to the serving network device a message to trigger the serving network device to reconfigure a modulation mode, based on the received modulation granularity rule. The more details have been described in the above descriptions with respect to at least the modulation granularity rule 512, the operations 542 and 572, and the trigger messages 544 and 574, and repetitive descriptions thereof are omitted here.

FIG. 10 shows a flow chart illustrating an example method 1000 for terahertz channel communication according to the example embodiments of the present disclosure. The example method 1000 may be performed for example by a network device for communication such as the network device 210.

Referring to the FIG. 10, the example method 1000 may include an operation 1010 of transmitting to a plurality of terminal devices, distance aware information comprising a distance-bandwidth mapping table; an operation 1020 of receiving from at least part of the plurality of terminal devices, respective terminal aware information comprising positioning information and channel state information, and optionally information on an available bandwidth; an operation 1030 of pairwise coupling the at least part of the plurality of terminal devices based on the respective terminal aware information to form one or more pairs of terminal devices, a pair of terminal devices comprising a closer terminal device and a farther terminal device; and an operation 1040 of performing a hybrid modulation mode for the one or more pairs of terminal devices, respectively, the hybrid modulation mode comprising a hierarchical type modulation and another type modulation.

Details of the operation 1010 have been described in the above descriptions with respect to at least the distance aware information 212, and repetitive descriptions thereof are omitted here.

Details of the operation 1020 have been described in the above descriptions with respect to at least the UE aware information 246 and 276, and repetitive descriptions thereof are omitted here.

Details of the operation 1030 have been described in the above descriptions with respect to at least the operation 214, and repetitive descriptions thereof are omitted here.

Details of the operation 1040 have been described in the above descriptions with respect to at least the operation 218, and repetitive descriptions thereof are omitted here.

In some example embodiments, the example method 1000 may further include an operation of transmitting to the closer terminal device and the farther terminal device in the one or more pairs of terminal devices, respectively, a pairwise tag comprising the terminal aware information of the paired terminal device. The more details have been described in the above descriptions with respect to at least the pairwise tags 216 and 218, and repetitive descriptions thereof are omitted here.

In some example embodiments, in case of receiving from a terminal device of a pair of terminal devices, a tag change request comprising terminal aware information of a neighboring terminal device of the terminal device, the example method 1000 may further include an operation of merging the pairwise tag of the terminal device with the pairwise tag of the neighboring terminal device. The more details have been described in the above descriptions with respect to at least the tag change requests 248 and 278, and the operation 216, and repetitive descriptions thereof are omitted here.

In some example embodiments, in case of receiving from a terminal device of a pair of terminal devices, a mode change request, the example method 1000 may further include an operation of for the pair of terminal devices, regressing the hybrid modulation mode to the hierarchical type modulation. The more details have been described in the above descriptions with respect to at least the mode change requests 250 and 280, and the operation 220, and repetitive descriptions thereof are omitted here.

In some example embodiments, for respective pair of terminal devices, the performing of the hybrid modulation mode may comprise: dividing the available bandwidth of the closer terminal device into a common channel with the available bandwidth of the farther terminal device and a remaining channel of the closer terminal device; deciding a hierarchical modulation mode on the common channel of the farther terminal device and the closer terminal device jointly; and deciding a separate modulation mode on the remaining channel of the closer terminal device, and the hybrid modulation mode may be carried out to obtain transmission powers for the common channel and the remaining channel of the closer terminal device and the common channel of the farther terminal device, respectively, modulation orders for the common channel and the remaining channel of the closer terminal device and the common channel of the farther terminal device, respectively, and an expected data rate. The more details have been described in the above descriptions with respect to at least the operations 410, 430, and 450, and repetitive descriptions thereof are omitted here.

In some example embodiments, the example method 1000 may further include an operation of transmitting to the plurality of terminal devices, a modulation granularity rule; and an operation of in case of receiving from a terminal device of a pair of terminal devices, a trigger message, reconfiguring the hybrid modulation mode for the pair of terminal devices. The more details have been described in the above descriptions with respect to at least the modulation granularity rule 512, the trigger messages 544 and 574, and the operation 514, and repetitive descriptions thereof are omitted here.

FIG. 11 shows a block diagram illustrating an example device 1100 for terahertz channel communication according to the example embodiments of the present disclosure. The device, for example, may be at least part of a terminal device for communication such as the UE 240 or the UE 270 in the above examples.

As shown in the FIG. 11, the example device 1100 may include at least one processor 1110 and at least one memory 1120 that may store instructions 1130. The instructions 1130, when executed by the at least one processor 1110, may cause the device 1100 at least to perform the example method 900 described above.

In various example embodiments, the at least one processor 1110 in the example device 1100 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1110 may also include at least one other circuitry or element not shown in the FIG. 11.

In various example embodiments, the at least one memory 1120 in the example device 1100 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 1120 may include, but are not limited to, an electric, a magnetic, an optical, an electromagnetic, an infrared, or a semiconductor system, apparatus, or device or any combination of the above.

Further, in various example embodiments, the example device 1100 may also include at least one other circuitry, element, and interface, for example at least one I/O interface, at least one antenna element, and the like.

In various example embodiments, the circuitries, parts, elements, and interfaces in the example device 1100, including the at least one processor 1110 and the at least one memory 1120, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 240 or the UE 270 is not limited to the above example device 1100. Although in the FIG. 11, the at least one memory 1120 is shown separately from the at least one processor 1110, it may be appreciated that in some example embodiments the at least one memory 1120 may be inside the at least one processor 1110.

FIG. 12 shows a block diagram illustrating an example device 1200 for terahertz channel communication according to the example embodiments of the present disclosure. The device, for example, may be at least part of a network device for communication such as the network device 210 in the above examples.

As shown in the FIG. 12, the example device 1200 may include at least one processor 1210 and at least one memory 1220 that may store instructions 1230. The instructions 1230, when executed by the at least one processor 1210, may cause the device 1200 at least to perform the example method 1000 described above.

In various example embodiments, the at least one processor 1210 in the example device 1200 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1210 may also include at least one other circuitry or element not shown in the FIG. 12.

In various example embodiments, the at least one memory 1220 in the example device 1200 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 1220 may include, but are not limited to, an electric, a magnetic, an optical, an electromagnetic, an infrared, or a semiconductor system, apparatus, or device or any combination of the above.

Further, in various example embodiments, the example device 1200 may also include at least one other circuitry, element, and interface, for example at least one I/O interface, at least one antenna element, and the like.

In various example embodiments, the circuitries, parts, elements, and interfaces in the example device 1200, including the at least one processor 1210 and the at least one memory 1220, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 210 is not limited to the above example device 1200. Although in the FIG. 12, the at least one memory 1220 is shown separately from the at least one processor 1210, it may be appreciated that in some example embodiments the at least one memory 1220 may be inside the at least one processor 1210.

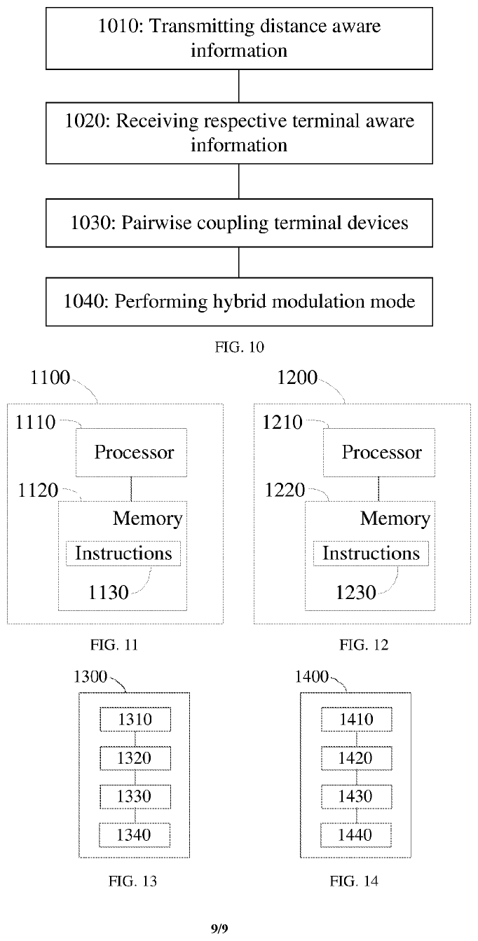

FIG. 13 shows a block diagram illustrating an example apparatus 1300 for terahertz channel communication according to the example embodiments of the present disclosure. The apparatus, for example, may be at least part of a terminal device for communication such as the UE 240 or the UE 270 in the above examples.

As shown in FIG. 13, the example apparatus 1300 may include means 1310 for performing the operation 910 of the example method 900, means 1320 for performing the operation 920 of the example method 900, means 1330 for performing the operation 930 of the example method 900, and means 1340 for performing the operation 940 of the example method 900. In one or more another example embodiments, at least one I/O interface, at least one antenna element, and the like may also be included in the example apparatus 1300.

In some example embodiments, in a case where there are more than one bandwidths available, the deciding of the available bandwidth may comprise: selecting one sub-bandwidth from the more than one bandwidths as the decided available bandwidth.

In some example embodiments, the example apparatus 1300 may further include means for receiving from the serving network device, a pairwise tag comprising terminal aware information of a paired terminal device.

In some example embodiments, the example apparatus 1300 may further include means for transmitting to the serving network device, a tag change request in case of monitoring a pairwise tag of a neighboring terminal device.

In some example embodiments, in a case where the terminal device fails to support a current modulation mode, the example apparatus 1300 may further include means for transmitting to the serving network device, a mode change request for regressing to a secondary modulation mode.

In some example embodiments, in case of receiving from the serving network device, a modulation granularity rule, the example apparatus 1300 may further include means for determining whether to transmit to the serving network device a message to trigger the serving network device to reconfigure a modulation mode, based on the received modulation granularity rule.

In some example embodiments, examples of means in the example apparatus 1300 may include circuitries. For example, an example of means 1310 may include a circuitry configured to perform the operation 910 of the example method 900, an example of means 1320 may include a circuitry configured to perform the operation 920 of the example method 900, an example of means 1330 may include a circuitry configured to perform the operation 930 of the example method 900, and an example of means 1340 may include a circuitry configured to perform the operation 940 of the example method 900.

The example apparatus 1300 may further include means comprising circuitry configured to perform the example method 900. In some example embodiments, examples of means may also include software modules and any other suitable function entities.

FIG. 14 shows a block diagram illustrating an example apparatus 1400 for terahertz channel communication according to the example embodiments of the present disclosure. The apparatus, for example, may be at least part of a network device for communication such as the network device 210 in the above examples.

As shown in FIG. 14, the example apparatus 1400 may include means 1410 for performing the operation 1010 of the example method 1000, means 1420 for performing the operation 1020 of the example method 1000, means 1430 for performing the operation 1030 of the example method 1000, and means 1440 for performing the operation 1040 of the example method 1000. In one or more another example embodiments, at least one I/O interface, at least one antenna element, and the like may also be included in the example apparatus 1400.

In some example embodiments, the example apparatus 1400 may further include means for transmitting to the closer terminal device and the farther terminal device in the one or more pairs of terminal devices, respectively, a pairwise tag comprising the terminal aware information of the paired terminal device. The more details have been described in the above descriptions with respect to at least the pairwise tags 216 and 218, and repetitive descriptions thereof are omitted here.

In some example embodiments, in case of receiving from a terminal device of a pair of terminal devices, a tag change request comprising terminal aware information of a neighboring terminal device of the terminal device, the example apparatus 1400 may further include means for merging the pairwise tag of the terminal device with the pairwise tag of the neighboring terminal device.

In some example embodiments, in case of receiving from a terminal device of a pair of terminal devices, a mode change request, the example apparatus 1400 may further include means for, for the pair of terminal devices, regressing the hybrid modulation mode to the hierarchical type modulation.

In some example embodiments, for respective pair of terminal devices, the performing of the hybrid modulation mode may comprise: dividing the available bandwidth of the closer terminal device into a common channel with the available bandwidth of the farther terminal device and a remaining channel of the closer terminal device; deciding a hierarchical modulation mode on the common channel of the farther terminal device and the closer terminal device jointly; and deciding a separate modulation mode on the remaining channel of the closer terminal device, and the hybrid modulation mode may be carried out to obtain transmission powers for the common channel and the remaining channel of the closer terminal device and the common channel of the farther terminal device, respectively, modulation orders for the common channel and the remaining channel of the closer terminal device and the common channel of the farther terminal device, respectively, and an expected data rate.

In some example embodiments, the example apparatus 1400 may further include means for transmitting to the plurality of terminal devices, a modulation granularity rule; and means for, in case of receiving from a terminal device of a pair of terminal devices, a trigger message, reconfiguring the hybrid modulation mode for the pair of terminal devices.

In some example embodiments, examples of means in the example apparatus 1400 may include circuitries. For example, an example of means 1410 may include a circuitry configured to perform the operation 1010 of the example method 1000, an example of means 1420 may include a circuitry configured to perform the operation 1020 of the example method 1000, an example of means 1430 may include a circuitry configured to perform the operation 1030 of the example method 1000, and an example of means 1440 may include a circuitry configured to perform the operation 1040 of the example method 1000.

The example apparatus 1400 may further include means comprising circuitry configured to perform the example method 1000. In some example embodiments, examples of means may also include software modules and any other suitable function entities.

The example embodiments of the present disclosure also provide a computer readable medium comprising program instructions that, when executed by a terminal device for communication such as the UE 240 or the UE 270 in the above examples, may cause the terminal device at least to perform: receiving from a serving network device, distance aware information comprising a distance-bandwidth mapping table; deciding an available bandwidth based on the distance-bandwidth mapping table; determining terminal aware information of the terminal device; and transmitting to the serving network device, the terminal aware information, wherein the terminal aware information comprises positioning information and channel state information, and optionally information on the available bandwidth.

In some example embodiments, in a case where there are more than one bandwidths available, the deciding of the available bandwidth may comprise: selecting one sub-bandwidth from the more than one bandwidths as the decided available bandwidth.

In some example embodiments, the computer readable medium may further include instructions that, when executed by the terminal device, may cause the terminal device to further perform: receiving from the serving network device, a pairwise tag comprising terminal aware information of a paired terminal device.

In some example embodiments, the computer readable medium may further include instructions that, when executed by the terminal device, may cause the terminal device to further perform: transmitting to the serving network device, a tag change request in case of monitoring a pairwise tag of a neighboring terminal device.

In some example embodiments, in a case where the terminal device fails to support a current modulation mode, the computer readable medium may further include instructions that, when executed by the terminal device, may cause the terminal device to further perform: transmitting to the serving network device, a mode change request for regressing to a secondary modulation mode.

In some example embodiments, in case of receiving from the serving network device, a modulation granularity rule, the computer readable medium may further include instructions that, when executed by the terminal device, may cause the terminal device to further perform: determining whether to transmit to the serving network device a message to trigger the serving network device to reconfigure a modulation mode, based on the received modulation granularity rule.

The example embodiments of the present disclosure also provide a computer readable medium comprising program instructions that, when executed by a network device for communication such as the network device 210 in the above examples, may cause the network device at least to perform: transmitting to a plurality of terminal devices, distance aware information comprising a distance-bandwidth mapping table; receiving from at least part of the plurality of terminal devices, respective terminal aware information comprising positioning information and channel state information, and optionally information on an available bandwidth; pairwise coupling the at least part of the plurality of terminal devices based on the respective terminal aware information to form one or more pairs of terminal devices, a pair of terminal devices comprising a closer terminal device and a farther terminal device; and performing a hybrid modulation mode for the one or more pairs of terminal devices, respectively, the hybrid modulation mode comprising a hierarchical type modulation and another type modulation.

In some example embodiments, the computer readable medium may further include instructions that, when executed by the network device, may cause the network device to further perform: transmitting to the closer terminal device and the farther terminal device in the one or more pairs of terminal devices, respectively, a pairwise tag comprising the terminal aware information of the paired terminal device.

In some example embodiments, in case of receiving from a terminal device of a pair of terminal devices, a tag change request comprising terminal aware information of a neighboring terminal device of the terminal device, the computer readable medium may further include instructions that, when executed by the network device, may cause the network device to further perform: merging the pairwise tag of the terminal device with the pairwise tag of the neighboring terminal device.

In some example embodiments, in case of receiving from a terminal device of a pair of terminal devices, a mode change request, the computer readable medium may further include instructions that, when executed by the network device, may cause the network device to further perform: for the pair of terminal devices, regressing the hybrid modulation mode to the hierarchical type modulation.

In some example embodiments, for respective pair of terminal devices, the performing of the hybrid modulation mode may comprise: dividing the available bandwidth of the closer terminal device into a common channel with the available bandwidth of the farther terminal device and a remaining channel of the closer terminal device; deciding a hierarchical modulation mode on the common channel of the farther terminal device and the closer terminal device jointly; and deciding a separate modulation mode on the remaining channel of the closer terminal device, and the hybrid modulation mode may be carried out to obtain transmission powers for the common channel and the remaining channel of the closer terminal device and the common channel of the farther terminal device, respectively, modulation orders for the common channel and the remaining channel of the closer terminal device and the common channel of the farther terminal device, respectively, or an expected data rate.

In some example embodiments, the computer readable medium may further include instructions that, when executed by the network device, may cause the network device to further perform: transmitting to the plurality of terminal devices, a modulation granularity rule; and in case of receiving from a terminal device of a pair of terminal devices, a trigger message, reconfiguring the hybrid modulation mode for the pair of terminal devices.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the above description, the terms “terminal device”, “communication device”, “terminal”, “user equipment” and “UE” may be used interchangeably.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
BER bit error rate
bps bits per second
BPSK binary phase shift keying
BS base station
CDF cumulative density function
CSI channel state information
eNB evolved node B
gNB next generation node B
GNSS global navigation satellite system
HBM hierarchical bandwidth modulation
HM hierarchical modulation
PDF probability density function
QAM quadrature amplitude modulation
MQAM M-ary QAM
RSRP reference signal receiving power
RSRQ reference signal receiving quality
RSSI received signal strength indicator
SEP search extreme point
SNR signal to noise ratio
THz Terahertz
UE user equipment

1. A terminal device for communication, comprising:
at least one processor; and
at least one memory storing instructions that, when executed with the at least one processor, cause the terminal device at least to perform:
receiving from a serving network device, distance aware information comprising a distance-bandwidth mapping table;
deciding an available bandwidth based on the distance-bandwidth mapping table;
determining terminal aware information of the terminal device; and
transmitting to the serving network device, the terminal aware information, wherein the terminal aware information comprises positioning information and channel state information, and optionally information on the available bandwidth.

2. The terminal device of claim 1, wherein in a case where there are more than one bandwidths available, the deciding of the available bandwidth comprises:
selecting one sub-bandwidth from the more than one bandwidths as the decided available bandwidth.

3. The terminal device of claim 1, wherein the instructions, when executed with the at least one processor, cause the terminal device to further perform:
receiving from the serving network device, a pairwise tag comprising terminal aware information of a paired terminal device.

4. The terminal device of claim 3, wherein the instructions, when executed with the at least one processor, cause the terminal device to further perform:
transmitting to the serving network device, a tag change request in case of monitoring a pairwise tag of a neighboring terminal device.

5. The terminal device of claim 1, wherein in a case where the terminal device fails to support a current modulation mode, the instructions, when executed with the at least one processor, cause the terminal device to further perform:
transmitting to the serving network device, a mode change request for regressing to a secondary modulation mode.

6. The terminal device of claim 1, wherein in case of receiving from the serving network device, a modulation granularity rule, the instructions, when executed with the at least one processor, cause the terminal device to further perform:
determining whether to transmit to the serving network device a message to trigger the serving network device to reconfigure a modulation mode, based on the received modulation granularity rule.

7. A network device for communication, comprising:
at least one processor; and
at least one memory storing instructions that, when executed with the at least one processor, cause the network device at least to perform:
transmitting to a plurality of terminal devices, distance aware information comprising a distance-bandwidth mapping table;
receiving from at least part of the plurality of terminal devices, respective terminal aware information comprising positioning information and channel state information, and optionally information on an available bandwidth;
pairwise coupling the at least part of the plurality of terminal devices based on the respective terminal aware information to form one or more pairs of terminal devices, a pair of terminal devices comprising a closer terminal device and a farther terminal device; and
performing a hybrid modulation mode for the one or more pairs of terminal devices, respectively, the hybrid modulation mode comprising a hierarchical type modulation and another type modulation.

8. The network device of claim 7, wherein the instructions, when executed with the at least one processor, cause the network device to further perform:
transmitting to the closer terminal device and the farther terminal device in the one or more pairs of terminal devices, respectively, a pairwise tag comprising the terminal aware information of the paired terminal device.

9. The network device of claim 8, wherein in case of receiving from a terminal device of a pair of terminal devices, a tag change request comprising terminal aware information of a neighboring terminal device of the terminal device, the instructions, when executed with the at least one processor, cause the network device to further perform:
merging the pairwise tag of the terminal device with the pairwise tag of the neighboring terminal device.

10. The network device of claim 7, wherein in case of receiving from a terminal device of a pair of terminal devices, a mode change request, the instructions, when executed with the at least one processor, cause the network device to further perform:
for the pair of terminal devices, regressing the hybrid modulation mode to the hierarchical type modulation.

11. The network device of claim 7, wherein for a respective pair of terminal devices, the performing of the hybrid modulation mode comprises the instructions causing the network device to perform:
dividing the available bandwidth of the closer terminal device into a common channel with the available bandwidth of the farther terminal device and a remaining channel of the closer terminal device;
deciding a hierarchical modulation mode on the common channel of the farther terminal device and the closer terminal device jointly; and
deciding a separate modulation mode on the remaining channel of the closer terminal device; and
wherein the hybrid modulation mode is carried out to obtain,
transmission powers for the common channel and the remaining channel of the closer terminal device and the common channel of the farther terminal device, respectively,
modulation orders for the common channel and the remaining channel of the closer terminal device and the common channel of the farther terminal device, respectively, and
an expected data rate.

12. The network device of claim 7, wherein the instructions, when executed with the at least one processor, cause the network device to further perform:
transmitting to the plurality of terminal devices, a modulation granularity rule; and
in case of receiving from a terminal device of a pair of terminal devices, a trigger message, reconfiguring the hybrid modulation mode for the pair of terminal devices.

13. A method for communication performed with a terminal device, comprising:
receiving from a serving network device, distance aware information comprising a distance-bandwidth mapping table;
deciding an available bandwidth based on the distance-bandwidth mapping table;
determining terminal aware information of the terminal device; and
transmitting to the serving network device, the terminal aware information, wherein the terminal aware information comprises positioning information and channel state information, and optionally information on the available bandwidth.

14. The method of claim 13, wherein in a case where there are more than one bandwidths available, the deciding of the available bandwidth comprises:
selecting one sub-bandwidth from the more than one bandwidths as the decided available bandwidth.

15. The method of claim 13, further comprising:
receiving from the serving network device, a pairwise tag comprising terminal aware information of a paired terminal device.

16. The method of claim 15, further comprising:
transmitting to the serving network device, a tag change request in case of monitoring a pairwise tag of a neighboring terminal device.

17. The method of claim 13, wherein in a case where the terminal device fails to support a current modulation mode, the method further comprises:
transmitting to the serving network device, a mode change request for regressing to a secondary modulation mode.

18. The method of claim 13, wherein in case of receiving from the serving network device, a modulation granularity rule, the method further comprises:
determining whether to transmit to the serving network device a message to trigger the serving network device to reconfigure a modulation mode, based on the received modulation granularity rule.

19-26. (canceled)
